(19) United States
(12) Patent Application Publication
(10) Pub. No.: US 2018/0115666 A1
(43) Pub. Date: Apr. 26, 2018

(54) APPLICATION STORE FOR MULTIFUNCTION PERIPHERALS

(71) Applicants: Kabushiki Kaisha Toshiba, Minato-ku (JP); Toshiba TEC Kabushiki Kaisha, Shinagawa-ku (JP)

(72) Inventors: Louis M. ORMOND, Irvine, CA (US); Marianne KODIMER, Huntington Beach, CA (US)

(21) Appl. No.: 15/692,038

(22) Filed: Aug. 31, 2017

Related U.S. Application Data
(60) Provisional application No. 62/410,537, filed on Oct. 20, 2016.

(51) Int. Cl. H04N 1/00; G06F 3/12

(52) U.S. Cl. CPC H04N 1/00514; H04N 1/0097; H04N 1/00411; G06F 3/1272; H04N 2201/0094; H04N 1/00938

(57) ABSTRACT

A system and method for downloading applications and user interfaces onto multifunction peripherals includes a document processing controller of a multifunction peripheral that is configured to communicate across a network with an application store or other repository downloadable items. Through the front panel display of the multifunction peripheral, a user selects an icon to initially open the application store. The document processing controller receives a web page or other data from the application store that details the applications and user interfaces available for download. The available items are displayed to the user, the user selects one or more items for download, and the selected items are downloaded onto the multifunction peripheral. Once downloaded, the user can select the items via the front panel display of the multifunction peripheral to execute downloaded applications or to use a customized user interface on the multifunction peripheral.

### RELATED APPLICATIONS

This application claims the benefit of U.S. Provisional Applications Ser. No. 62/410,573 filed Oct. 20, 2016 which is herein incorporated by reference in its entirety.

### TECHNICAL FIELD

This application relates generally to customization of multifunction peripherals. The application relates more particularly to the loading of applications and customized user interfaces from an application store onto multifunction peripherals.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFP means any of the forgoing.

MFPs are typically provided with a fixed set of functions, such as printing, copying, scanning and e-mailing, that are available to device end users. MFPs can include options such as hole punching or stapling, printing in black and white or in color, and scanning to an image file or a text-inclusive file via optical character recognition. These, and other options, are typically selectable by device users via a user interface, such as a touchscreen display integrated into an MFP.

MFPs are configurable computing devices that can execute applications to extend the default printing, copying, scanning, and emailing capabilities. MFPs have limited memory for storing applications, and therefore administrators generally install applications on MFPs only when needed by end users. Different users may desire to have different applications, or customized user interface options, available on particular MFPs, requiring additional management by administrators. When new or updated applications become available, users and administrators may desire to selectively install the new or updated applications to particular MFPs. The new or updated applications are installed using a local interface to the MFP, for example using USB or via HTTP, however this requires the user or administrator to have access to the MFP.

### SUMMARY

In accordance with an example embodiment of the subject application, a system and method for downloading applications and user interfaces onto multifunction peripherals includes a document processing controller having a processor and a memory. The memory is configured to store downloaded applications that can be executed by the processor. A print engine can print pages in accordance with instructions from the controller. A network interface is configured to receive data, such as a web page, that details the applications and user interfaces that can be downloaded from an associated application repository, such as an app store or application server. A display, for example a touchscreen display, presents the list of downloadable applications and user interfaces to users of the multifunction peripheral, for example by displaying the received web page. A user input, such a software control on the touchscreen display, receives a user selection of one or more applications or user interfaces, and the selected application or user interface is received from the application repository across the network interfaces. The downloaded applications can be viewed by users selectively executed when selected. The downloaded user interfaces can be displayed on the multifunction peripheral as the user interface.

### BRIEF DESCRIPTION OF THE DRAWINGS

Various embodiments will become better understood with regard to the following description, appended claims and accompanying drawings wherein:

FIG. 1 is an example embodiment of an electronic business network for downloading applications and customized user interfaces to MFPs;

FIG. 2 is an example embodiment of a document rendering system;

FIG. 3 is a first example screenshot from an MFP configured to download applications and customized user interfaces;

FIG. 4 is a second example screenshot from an MFP configured to download applications and customized user interfaces;

FIG. 5 is a third example screenshot from an MFP configured to download applications and customized user interfaces;

FIG. 6 is a fourth example screenshot from an MFP configured to download applications and customized user interfaces;

FIG. 7 is a first example screenshot from a distribution system configured to download applications and customized user interfaces to MFPs;

FIG. 8 is a second example screenshot from a distribution system configured to download applications and customized user interfaces to MFPs; and

FIG. 9 is an example screenshot of a webpage for configuring downloadable applications and customized user interfaces for MFPs.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

MFPs are increasingly powerful and capable of performing advanced functions in addition to printing, faxing, emailing, and scanning Applications can be loaded onto MFPs to enable additional functionality on MFPs. To take advantage of this additional functionality, applications can be selectively loaded onto the MFP and executed by users.

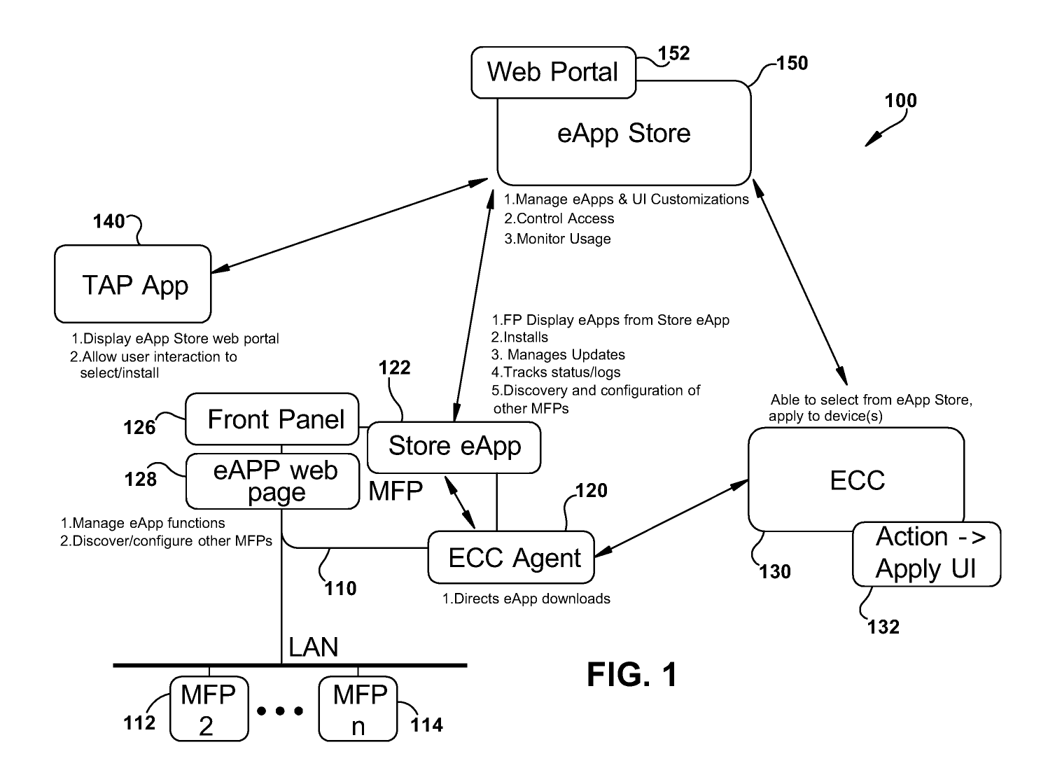

Referring to FIG. 1, an embodiment of an electronic business network 100 for downloading applications and customized user interfaces onto MFPs is presented. One or more MFPs 110, 112, 114 are in data communication with servers associated with the electronic business network 100 via network 102. Network 102 is suitably comprised of a local area network (LAN) as shown, a wide area network (WAN), which may include the global Internet, or any suitable combination thereof.

By installing and executing a suitable application on MFP 110, MFP 110 can communicate with an application server to download applications and customized user interfaces, such as eApp Store 150. A web portal 152 on the eApp Store 150 can serve eApp web pages 128 that are displayed on the front panel display 126 of the MFP 110. A user can interact with the eApp Store 150 through the front panel display 126 to select, download, and install applications and customized user interfaces on the MFP 110. In a configuration, an administrator can discover and configure other MFPs 112, 114 through the front panel display 126 of the MFP 110. An application distribution server, such as TAP 140 from Toshiba Australia, can similarly access the eApp Store, for example through the web portal 152, to select and install eApps and customized user interfaces on MFPs 110.

A Store eApp Agent 122, provides an interface between the eApp Store 150 and the MFP 110. The Store eApp Agent 122 initiates a connection to the eApp Store 150 when launched. The first time that the Store eApp Agent 122 connects to the eApp Store 150, the Store eApp Agent 122 registers with the eApp Store 150. The Store eApp Agent 122 can use a registration token or another suitable authentication method for subsequent connections with the eApp Store 150. Once registered, the Store eApp Agent 122 will send information about the MFP 110 to the eApp Store 150, such as the serial number of the MFP 110, the model of the MFP 110, and a list of installed applications and user interfaces on the MFP 110. The Store eApp Agent 122 controls what is displayed on the front panel display 126 to users. Once the Store eApp Agent 122 has registered or reconnected to the eApp Store 150, the Store eApp Agent 122 can display a properly formatted storefront for the eApp Store 150 and display content available for download by the user to the MFP 110. The Store eApp Agent 122 can install applications, or eApps, selected by the user from the eApp Store 150 onto the MFP 110. If a license key is required, the Store eApp Agent 122 can prompt as needed and the eApp Store 150 can confirm the license key against a license server (not shown) as would be understood in the art. The Store eApp Agent 122 can provide a progress bar or status indicator to the user, for example on the front panel display 126, that can allow a user to cancel a download if desired. Once downloaded and installed, the eApp can be displayed on the front panel display 126, selected by the user, and executed. The Store eApp Agent 122 can manage updates to eApps and customized user interfaces. The Store eApp Agent 122 can present a list of available updates to the user via the front panel display 126 that the user can select for installation on the MFP 110. In a configuration, the Store eApp Agent 122 can restore deleted customizations or provide back-up functions. The Store eApp Agent 122 can track or log actions, as well as manage the discovery and configuration of other MFPs 112, 114. For example, the Store eApp Agent 122 can discover other MFPs 112, 114 on the local network 102, display the results to a user, receive user selections, and push updates to one or more of the MFPs 112, 114, for example to clone the functions of the MFP 110 to other MFPs 112, 114.

The MFP 110 can communicate with a device management server of the electronic business network 110, such as eBRIDGE CloudConnect (ECC 130) of Toshiba TEC. An ECC agent 120 executing on the MFP 110 provides a communications interface to the ECC 130. The Store eApp Agent 122 first subscribes to the ECC agent 120. The ECC agent 120 can notify the Store eApp Agent 122 of updates when available. The Store eApp Agent 122 can receive update instructions from the ECC agent 120. The Store eApp Agent 122 can process the updates, and provide status back to the ECC agent 120. The ECC agent 120 reports status back to the ECC 130. In an example operation, an administrator instructs the ECC 130 to perform an action 132, for example to apply a particular user interface to the MFP 110. The ECC agent 120 receives the selected user interface from the ECC 130 and Store eApp Agent 122 applies the designated user interface to the MFP 110. In a configuration, the ECC agent 120 can poll the ECC 130, for example to obtain updates to applications and customized user interfaces. The ECC 130 can track pending downloads, completed downloads, updates to eApps, and failed downloads. The ECC 130 can keep a log of eApps and customized user interfaces that have been installed to MFPs 110, including a timestamp of each installation, and can keep track of which versions of eApps have been installed on MFPs 110.

The ECC 130 can also communicate with the eApp Store 150, for example to download a particular application, or a customized user interface, that is then pushed out to one or more MFPs 110. The eApp Store 150 provides an online repository of applications, or eApps, and customized user interfaces and that can be downloaded to MFPs 110. The eApp Store 150 can manage updates of eApps and user interfaces, provide control of access to eApps and user interfaces, track status of downloads and generate logs.

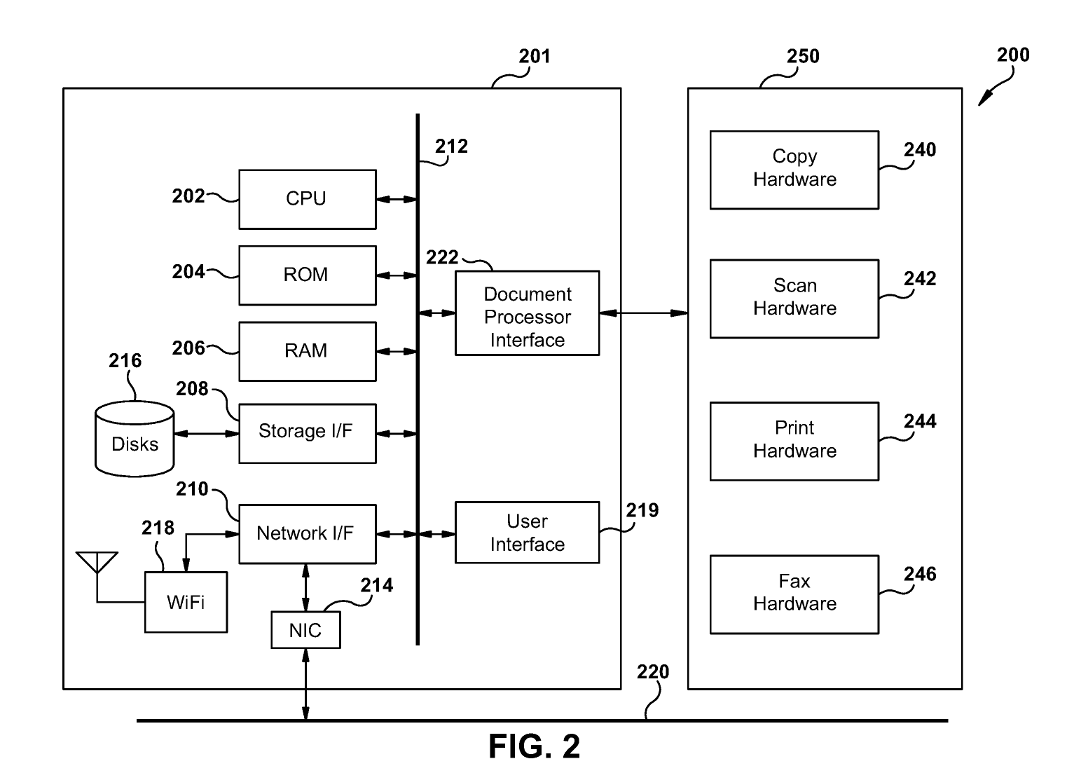

Turning now to FIG. 2, illustrated is an example embodiment of a document rendering system 200 suitably comprised within an MFP 110, such as with MFPs 112, and 114 of FIG. 1. Included is controller 201 comprised of one or more processors, such as that illustrated by processor 202. Each processor is suitably associated with non-volatile memory such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Apple Lightning, telephone line, or the like.

Processor 202 can also be in data communication with any suitable user input/output (I/O) interface 219 which provides data communication with user peripherals, such as a front panel display or displays, keyboards, mice, track balls, touch screens, or the like.

Also in data communication with data bus 212 is a document processor interface 222 suitable for data communication with MFP functional units 250. In the illustrated example, these units include copy hardware 240, scan hardware 242, print hardware 244 and fax hardware 246 which together comprise MFP functional hardware 250. A hardware monitor suitably provides device event data, working in concert with suitable monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 216. It will be understood that functional units are suitably comprised of intelligent units, including any suitable hardware or software platform.

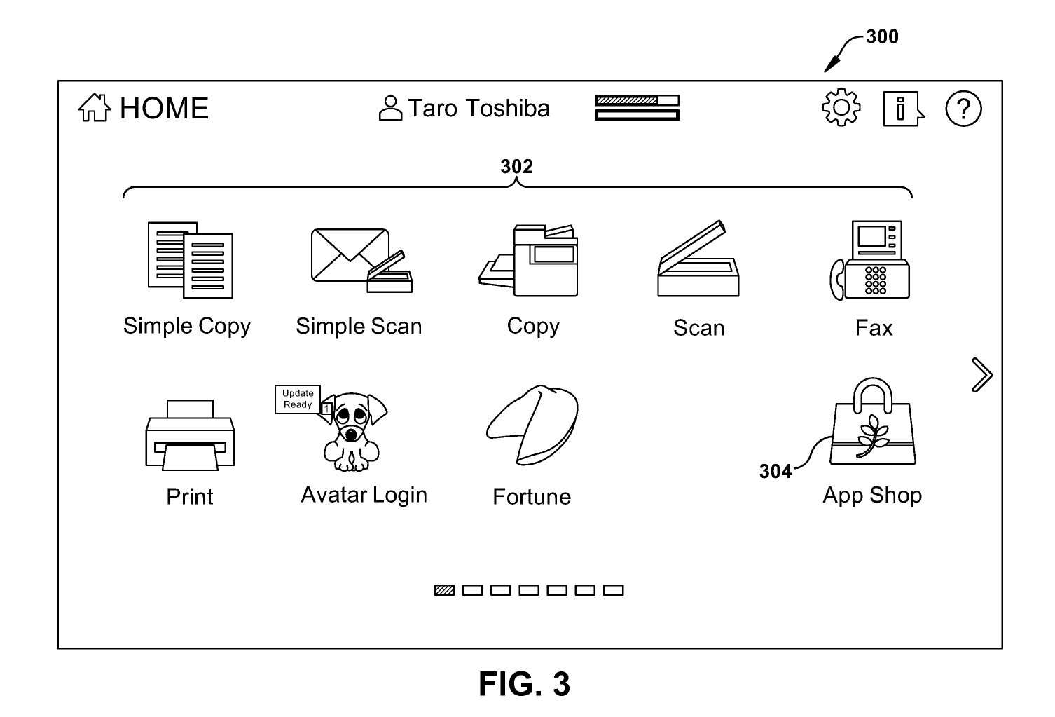

FIG. 3 is a first example screenshot 300 of a front panel display of an MFP such as MFP 110, 112 or 114 of FIG. 1. The front panel display includes selectable controls 302 for copying, scanning, faxing, printing, and so forth. The selectable controls 302 also include an App Shop control 304 for downloading applications and customized user interfaces from a suitable repository. A user can select the App Shop control 304 to view downloadable items from an associated App Shop, such as the eApp Store 150 of FIG. 1.

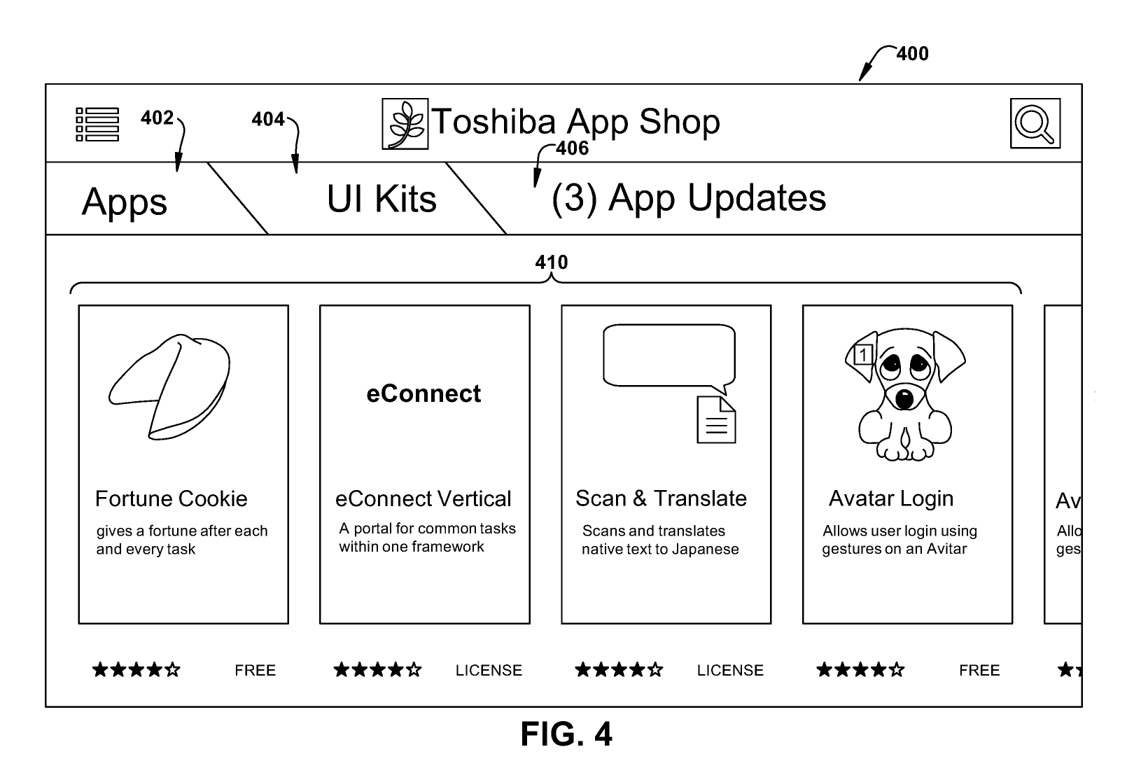

FIG. 4 is a second example screenshot 400 of a front panel display of an MFP that is displayed after a user has selected the App Shop control 304 of FIG. 3 to view downloadable items from the App Shop. The App Shop can include an App tab 402, an UI or User Interface tab 404, and an App Update tab 406 among other suitable tabs for categorizing and organizing downloadable items in a suitable menu system. When the App tab 402 is selected, a list of downloadable applications 410 is presented. A user can select one of the downloadable applications 410 to install it on the MFP.

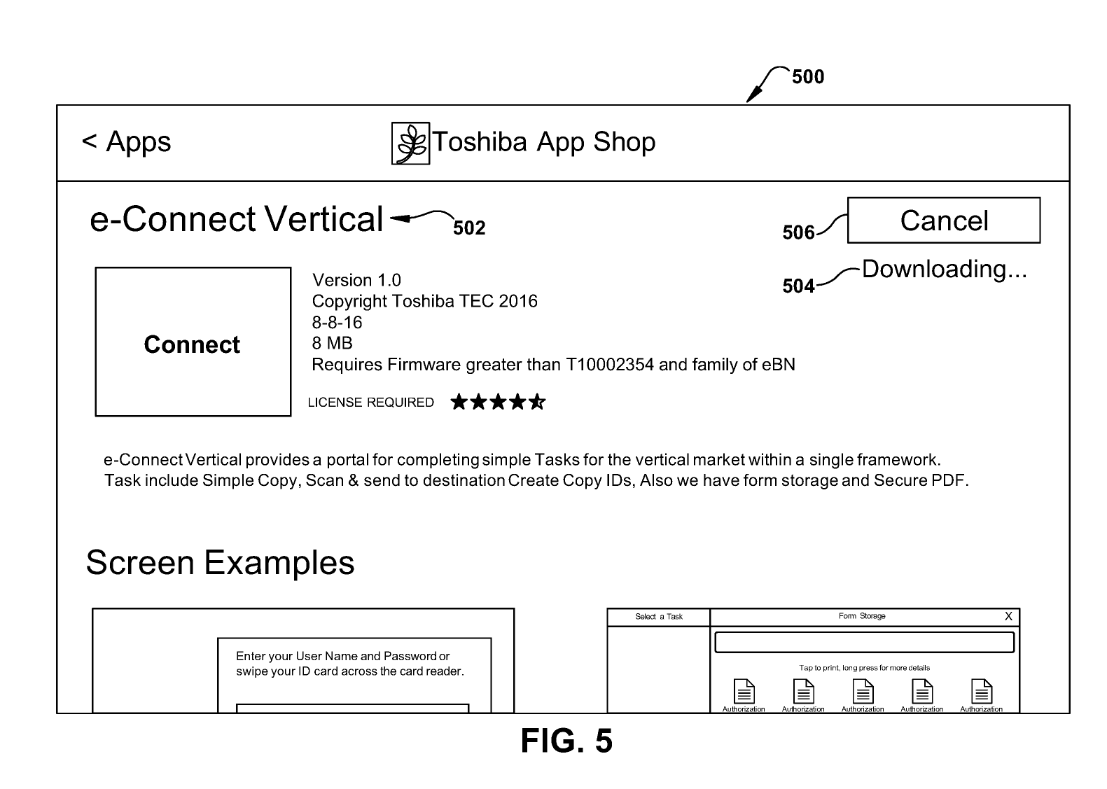

FIG. 5 is a third example screenshot 500 of a front panel display of an MFP that is displayed after a user has selected one of the downloadable applications 410 of FIG. 4. The selected application 502 is downloaded to the MFP, and the user is presented with a progress bar 504 and a cancel control 506 to cancel the download. Additional information about the application that is downloading can be displayed, such as version information, hardware requirements, and screenshots of the selected application 502.

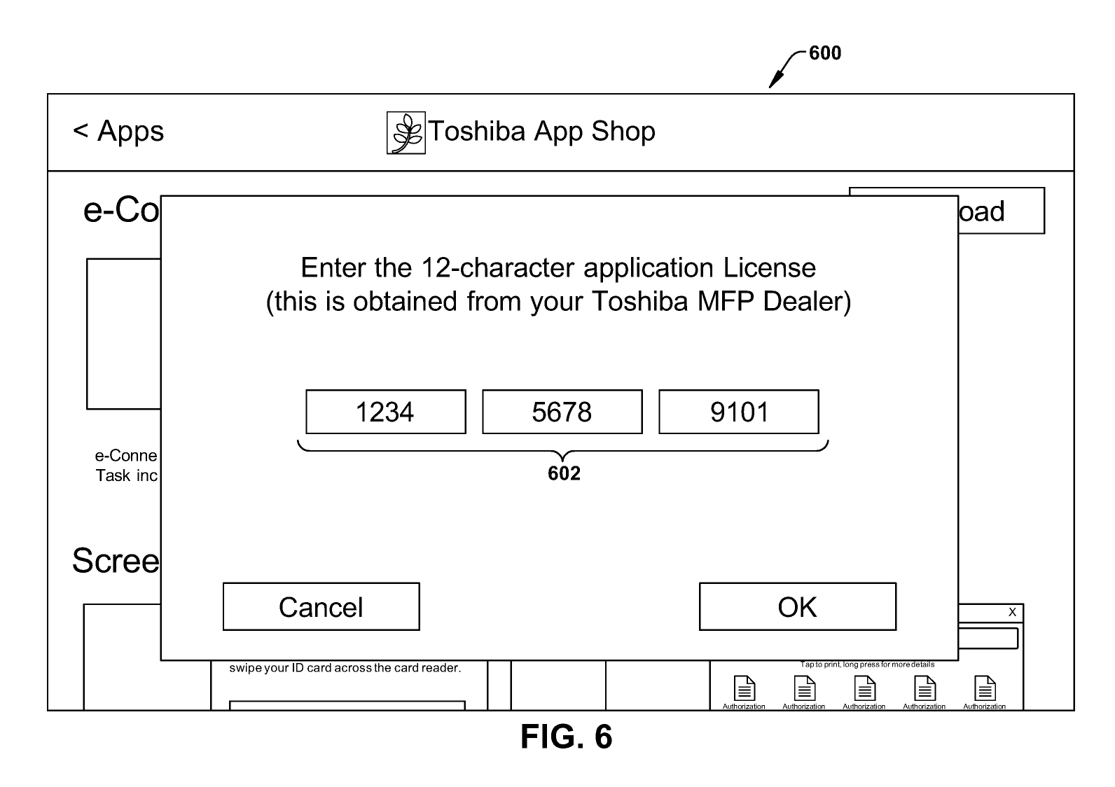

FIG. 6 is a fourth example screenshot 600 of a front panel display of an MFP. If the selected application 502 of FIG. 5 requires a license key 602, the user of the MFP can be prompted with a control to enter the license key 602. The App Shop can perform the necessary licensing operations with a suitable license server as described above.

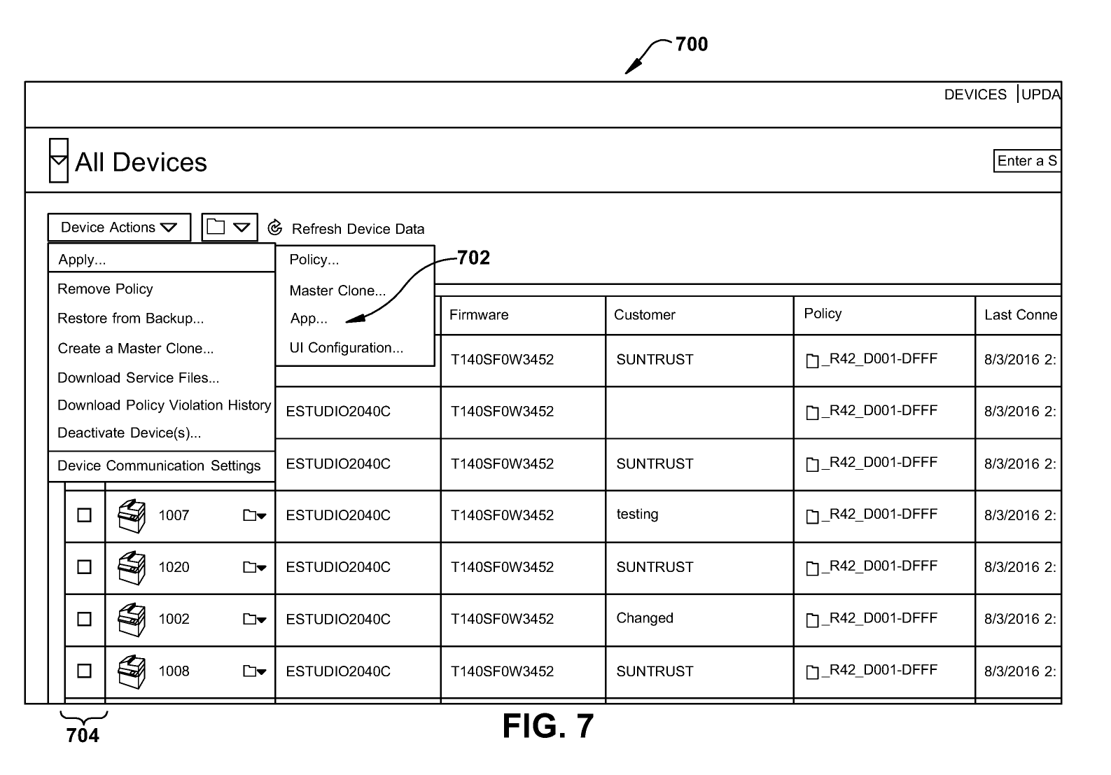

FIG. 7 is a first example screenshot 700 of a device management server interface, such as the eBRIDGE CloudConnect (ECC 130) of Toshiba TEC of FIG. 1. The device management server interface can include an App download control 702 for downloading an application onto one or more MFPs selected by the user via MFP selection controls 704.

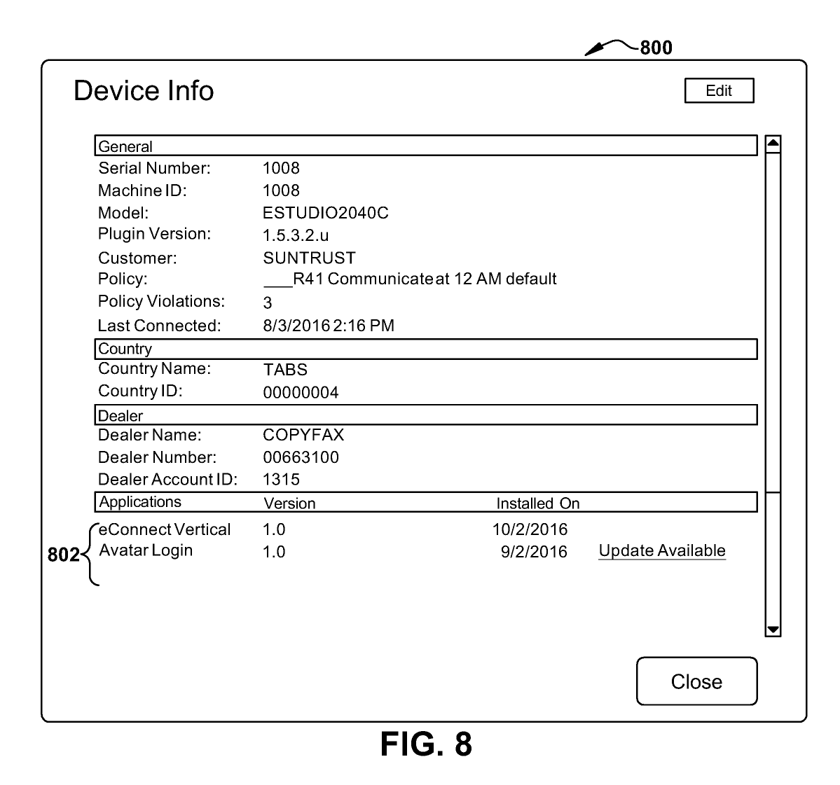

FIG. 8 is a second example screenshot 800 of the device management server interface. A user can view device info of a selected MFP from FIG. 7. The device info can include a list of items 802 previously downloaded to the selected MFP, such as applications and customized user interfaces. The list of items 802 can include the names of the items, the versions of the items, the date the items were installed, and whether or not updates are available for the items.

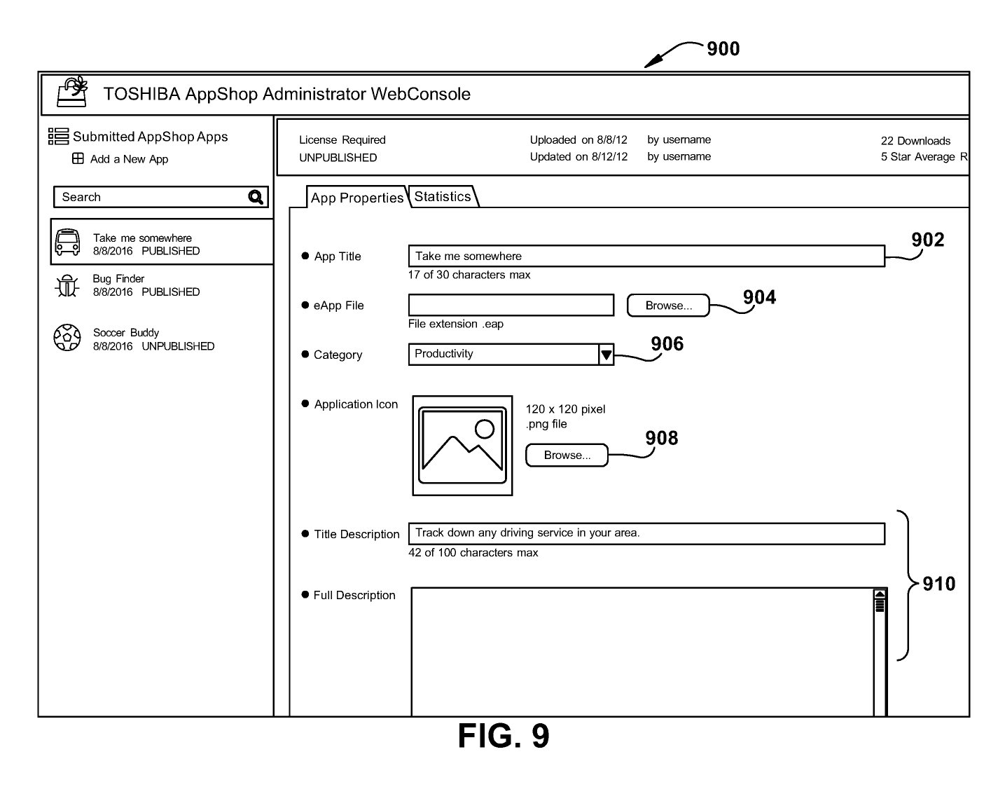

FIG. 9 is an example screenshot 900 of a webpage, or console, for configuring applications and customized user interfaces that are available for download via the App Shop of FIG. 4. Generally this is performed by a system administrator who configures the items available from the App Shop. Through the webpage or console, the system administrator can provide the title 902 of the app, the file name 904 and file location of the app, a suitable category 906 for the app, and an icon 908 to be represent the app in the App Shop, among other suitable descriptive information 910 such as a description of the app and screenshots of the app that can be displayed on the MFP front panel display, for example as illustrated in the third example screenshot 500 of FIG. 5.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A multifunction peripheral comprising:
a document processing controller including,
a processor, and
a memory configured to store a plurality of downloaded applications for execution by the processor,
a print engine configured to print pages in accordance with instructions issued from the controller;
a network interface configured to receive data detailing a plurality of applications downloadable from an associated application repository; and
a display configured to display a plurality of downloadable applications based on the received data.

2. The multifunction peripheral of claim 1, further comprising:
a user input configured to receive a user selection of a selected downloadable application from the displayed plurality of downloadable applications,
wherein the network interface is further configured to receive the selected downloadable application from the associated application repository, and
wherein the memory is configured to store the received downloadable application as a downloaded application,

3. The multifunction peripheral of claim 2,
wherein the display is further configured to display a user selectable control associated with the downloaded application,
wherein the user input is further configured to receive a user selection of the user selectable control associated with the downloaded application, and
wherein the processor is further configured to execute the downloaded application in response to the user selection.

4. The multifunction peripheral of claim 1,
wherein the memory is further configured to store at least one downloadable user interface for the multifunction peripheral,
wherein the network interface is further configured to receive data detailing a plurality of user interfaces downloadable from the associated application repository, and
wherein the display is further configured to display a plurality of downloadable user interfaces based on the received data.

5. The multifunction peripheral of claim 4, further comprising:
a user input configured to receive a user selection of a selected user interface from the displayed plurality of downloadable user interfaces,
wherein the network interface is further configured to receive the selected user interface from the associated application repository, and
wherein the memory is configured to store the received user interface as a downloaded user interface.

6. The multifunction peripheral of claim 5,
wherein the display is further configured to display a user selectable control associated with the downloaded user interface,
wherein the user input is further configured to receive a user selection of the user selectable control associated with the downloaded user interface, and
wherein the processor is further configured to use the downloaded user interface as the user interface for the multifunction peripheral in response to the user selection.

7. The multifunction peripheral of claim 1, wherein the data detailing the plurality of downloadable applications is a web page received via the network interface from a web server associated with the application repository.

8. The multifunction peripheral of claim 1, wherein the display is a touchscreen display and wherein the user input is a software-based control associated with the touchscreen display.

9. The multifunction peripheral of claim 1, further comprising
the application repository including,
a processor,
a memory configured to store a plurality of downloadable applications for execution by the multifunction peripheral, and
a network interface configured to transmit data detailing the plurality of downloadable applications to the multifunction peripheral,
wherein the network interface is further configured to receive a request to transmit one or more of the downloadable applications to the multifunction peripheral, and
wherein the network interface is further configured to transmit the one or more downloadable applications to the multifunction peripheral in response to the request.

10. The multifunction peripheral of claim 9,
wherein memory of the application repository is further configured to store a plurality of downloadable user interfaces for the multifunction peripheral,
wherein the network interface is further configured to transmit data detailing the plurality of downloadable user interfaces to the multifunction peripheral,
wherein the network interface is further configured to receive a request to transmit a downloadable user interface to the multifunction peripheral, and
wherein the network interface is further configured to transmit the downloadable user interface to the multifunction peripheral in response to the request.

11. A method comprising:
receiving, on a user input of a multifunction peripheral, a request to display downloadable applications available for downloading from an application store for multifunction peripherals,
receiving, on a network interface of a multifunction peripheral, data identifying a plurality of downloadable applications available for downloading from the application store; and
displaying, on a display of the multifunction peripheral, the plurality of downloadable applications based on the received data.

12. The method of claim 11, further comprising:
receiving, on the user input, a selection of a selected downloadable application from the plurality of downloadable applications displayed on the display;
receiving, on the network interface, the selected downloadable application from the application store; and
storing, in a memory of the multifunction peripheral, the selected downloadable application as a downloaded application.

13. The method of claim 12, further comprising:
displaying, on the display, a user selectable control associated with the downloaded application;
receiving, on the user input, a user selection of the user selectable control; and
executing, by a processor of the multifunction peripheral, the downloaded application associated with the selected user selectable control.

14. The method of claim 11, further comprising:
receiving, on the network interface, data identifying a plurality of downloadable user interfaces available for downloading from the application store; and
displaying, on the display, the plurality of downloadable user interfaces based on the received data.

15. The method of claim 14, further comprising:
displaying, on the display, a user selectable control associated with each user interface;
receiving, on the user input, a user selection of the user selectable control; and
displaying, on the display, the user interface associated with the selected user selectable control.

16. The method of claim 12, wherein the data identifying the plurality of downloadable applications is a web page received via the network interface from a web server associated with the application store.

17. The method of claim 12, wherein the display is a touchscreen display and wherein the user input is a software-based control associated with the touchscreen display.

18. A system, comprising:
a multifunction peripheral including
a document processing controller configured to store, in memory, one or more applications downloaded from an associated application store, and selectively execute the one or more applications in accordance with user selections,
a touchscreen display configured to present the one or more applications stored in memory in a user selectable format, and
an input, associated with the touchscreen display, configured to receive user selections of applications to be executed by the controller.

19. The system of claim 18,
wherein the document processing controller is further configured to receive data associated with a plurality of applications available for download by the multifunction peripheral from the application store,
wherein the touchscreen display is further configured to present the plurality of applications available for download in a user selectable format,
wherein the input configured to receive user selections of applications to be download, and
wherein the document processing controller is further configured to receive, from the application store, applications associated with the user selections, and store the received applications in memory.

20. The system of claim 18, further comprising:
an application store having a memory configured to store a plurality of downloadable applications for execution on multifunction peripherals,
wherein the application store is configured to selectively download one or more of the downloadable applications to one or more multifunction peripherals.
